(19) United States
(12) Patent Application Publication
(10) Pub. No.: US 2015/0160702 A1
(43) Pub. Date: Jun. 11, 2015

(54) Hot Swappable Computer Cooling System

(71) Applicant: Silicon Graphics International Corp., Fremont, CA (US)

(72) Inventor: Perry Dennis Franz, Elk Mound, WI (US)

(73) Assignee: Silicon Graphics International Corp., Fremont, CA (US)

(21) Appl. No.: 14/102,121

(22) Filed: Dec. 10, 2013

(51) Int. Cl. G06F 1/20

(52) U.S. Cl. CPC G06F 1/20

(57) ABSTRACT

A computer system has a liquid cooling system with a main portion, a cold plate, and a closed fluid line extending between the main portion and the cold plate. The cold plate has an internal liquid chamber fluidly connected to the closed fluid line. The computer system also has a hot swappable computing module that is removably connectable with the cold plate. The cold plate and computing module are configured to maintain the closed fluid line between the main portion and the cold plate when the computing module is being connected to or removed from the cold plate.

### FIELD OF THE INVENTION

Illustrative embodiments of the invention generally relate to computer systems and, more particularly, the illustrative embodiments of the invention relate to cooling computer systems.

### BACKGROUND OF THE INVENTION

Energized components within an electronic system generate waste heat. If not properly dissipated, this waste heat can damage the underlying electronic system. For example, if not properly cooled, the heat from a microprocessor within a conventional computer chassis can generate enough heat to melt its own traces, interconnects, and transistors. This problem often is avoided, however, by simply using forced convection fans to direct cool air into the computer chassis, forcing hot air from the system. This cooling technique has been the state of the art for decades and continues to cool a wide variety of electronic systems.

Some modern electronic systems, however, generate too much heat for convection fans to be effective. For example, as component designers add more transistors to a single integrated circuit (e.g., a microprocessor), and as computer designers add more components to a single computer system, they sometimes exceed the limits of conventional convection cooling. Accordingly, in many applications, convection cooling techniques are ineffective.

The art has responded to this problem by liquid cooling components in thermally demanding applications. More specifically, those in the art recognized that many liquids transmit heat more easily than air—air is a thermal insulator. Taking advantage of this principal, system designers developed systems that integrate a liquid cooling system into the overall electronic system to remove heat from hot electronic components.

To that end, a coolant, which generally is within a fluid channel during operation, draws heat from a hot component via a low thermally resistant, direct physical connection. The coolant can be cycled through a cooling device, such as a chiller, to remove the heat from the coolant and direct chilled coolant back across the hot components. While this removes waste heat more efficiently than convection cooling, it presents a new set of problems. In particular, coolant that inadvertently escapes from its ideally closed fluid path (e.g., during a hot swap of a hot component) can damage the system. Even worse—escaped coolant can electrocute an operator servicing a computer system.

### SUMMARY OF VARIOUS EMBODIMENTS

In accordance with one embodiment of the invention, a computer system has a liquid cooling system with a main portion, a cold plate, and a closed fluid line extending between the main portion and the cold plate. The cold plate has an internal liquid chamber fluidly connected to the closed fluid line. The computer system also has a hot swappable computing module that is removably connectable with the cold plate. The cold plate and computing module are configured to maintain the closed fluid line between the main portion and the cold plate when the computing module is being connected to or removed from the cold plate.

Among other things, the computing module may include a blade. The computing module thus may include a printed circuit board and/or a plurality of integrated circuits. The liquid cooling system also can have a closed fluid loop that includes the internal liquid chamber within the cold plate.

The cold plate and computing module preferably have complimentary shapes to fit in registry when connected. For example, the computing module may form an internal fitting space having a first shape, while the exterior of the cold plate correspondingly also has the first shape and is sized to fit within the fitting space. The first shape may include a linearly tapering section (e.g., a wedge shaped portion).

The main portion also may include a manifold coupled with the cold plate. In this embodiment, the manifold may have a receiving manifold portion configured to receive a liquid coolant from the computing module, and a supply manifold portion configured to direct the liquid coolant toward the internal liquid chamber of the cold plate. In addition or alternatively, the computing module may have a module face, while the cold plate may have a corresponding plate face that is facing the module face. A thermal film may contact both the module face and the plate face to provide a continuous thermal path between at least a portion of these two faces.

In accordance with another embodiment of the invention, a high performance computing system has a liquid cooling system with a main portion, a plurality of cold plates, and a closed fluid line extending between the main portion and a plurality of the cold plates. The computing system also has a plurality of hot swappable computing modules. Each of the plurality of computing modules is removably connectable with one of the cold plates to form a plurality of cooling pairs. The cold plate and computing module of each cooling pair is configured to maintain the closed fluid line between the main portion and the cold plate when the computing module is being connected to or removed from the cold plate.

In accordance with other embodiments of the invention, a method of cooling a blade of a computer system provides a liquid cooling system having a main portion, a plurality of cold plates, and a closed fluid line extending between the main portion and the cold plates. The method removably couples each of a set of the cold plates in registry with one of a plurality of computing modules. Each cold plate and respective coupled computing module thus forms a cooling pair forming a part of the computer system. The system also energizes the computing modules, and hot swaps at least one of the computing modules while maintaining the closed fluid line between the main portion and the cold plate.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 schematically shows a logical view of an HPC system in accordance with one embodiment of the present invention.

FIG. 2 schematically shows a physical view of the HPC system of FIG. 1.

FIG. 3 schematically shows details of a blade chassis of the HPC system of FIG. 1.

FIG. 4A schematically shows a perspective view of system for cooling a plurality of blade servers in accordance with illustrative embodiments of the invention. This figure shows the cooling system without blades.

FIG. 4B schematically shows a side view of the cooling system shown in FIG. 4A.

FIG. 4C schematically shows a top view of the cooling system shown in FIG. 4A.

FIG. 5A schematically shows a perspective view of the cooling system of FIG. 4A with a plurality of attached blades configured in accordance with illustrative embodiments of the invention.

FIG. 5B schematically shows a side view of the system shown in FIG. 5A.

FIG. 5C schematically shows a top view of the system shown in FIG. 4A.

FIG. 6A schematically shows a cross-sectional side view of one cold plate and blade server before they are coupled together.

FIG. 6B schematically shows a top view of the same cold plate and blade server of FIG. 6A before they are coupled together.

FIG. 7A schematically shows the cold plate and blade server of FIGS. 6A and 6B with the components coupled together.

FIG. 7B schematically shows a top view of the components of FIG. 7A.

FIG. 8 shows a method of cooling a blade server in accordance with illustrative embodiments of the invention.

### DESCRIPTION OF ILLUSTRATIVE EMBODIMENTS

In illustrative embodiments, a computer component can be connected to, or removed from, its larger system with a negligible risk of a coolant leak. To that end, the computer system includes a computer component that may be removably connected to its liquid cooling system without breaking the liquid channel within the cooling system. Accordingly, when hot swapping the computer component, the cooling system liquid channels remained closed, protecting the user making the hot swap from potential electrocution. Details of illustrative embodiments are discussed below.

Many of the figures and much of the discussion below relate to embodiments implemented in a high performance computing (“HPC”) system environment. Those skilled in the art should understand, however, that such a discussion is for illustrative purposes only and thus, not intended to limit many other embodiments. Accordingly, some embodiments may be implemented on other levels, such as at the board level, or at the component level (e.g., cooling an integrated circuit, such as a microprocessor). Moreover, even at the system level, other embodiments apply to non-high-performance computing systems.

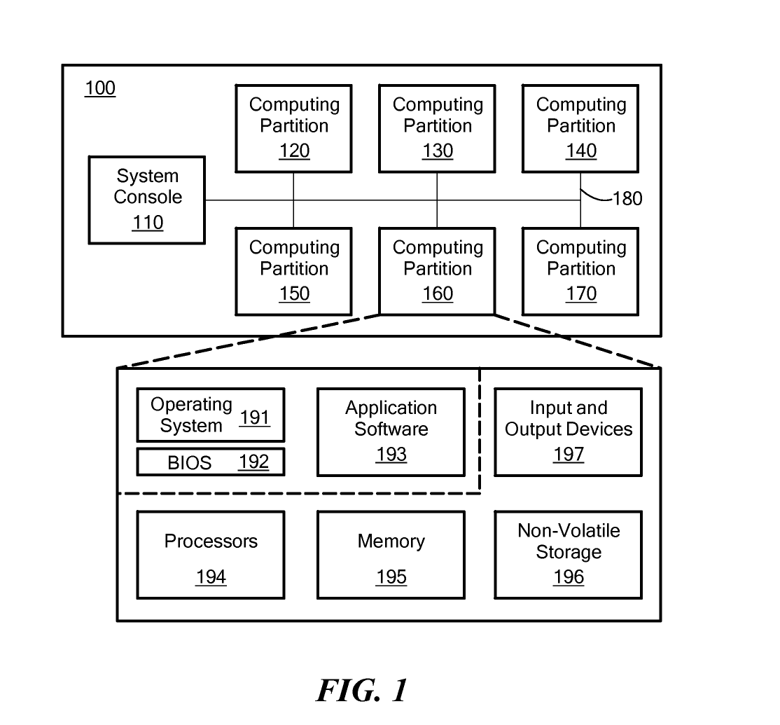

FIG. 1 schematically shows a logical view of an exemplary high-performance computing system 100 that may be used with illustrative embodiments of the present invention. Specifically, as known by those in the art, a “high-performance computing system,” or “HPC system,” is a computing system having a plurality of modular computing resources that are tightly coupled so that processors may access remote data directly using a common memory address space.

To those ends, the HPC system 100 includes a number of logical computing partitions 120, 130, 140, 150, 160, 170 for providing computational resources, and a system console 110 for managing the plurality of partitions 120-170. A “computing partition” (or “partition”) in an HPC system is an administrative allocation of computational resources that runs a single operating system instance and has a common memory address space. Partitions 120-170 may communicate with the system console 110 using a logical communication network 180. A system user, such as a scientist or engineer who desires to perform a calculation, may request computational resources from a system operator, who uses the system console 110 to allocate and manage those resources. The HPC system 100 may have any number of computing partitions that are administratively assigned as described in more detail below, and often has only one partition that encompasses all of the available computing resources. Accordingly, this figure should not be seen as limiting the scope of the invention.

Each computing partition, such as partition 160, may be viewed logically as if it were a single computing device, akin to a desktop computer. Thus, the partition 160 may execute software, including a single operating system (“OS”) instance 191 that uses a basic input/output system (“BIOS”) 192 as these are used together in the art, and application software 193 for one or more system users.

Accordingly, as also shown in FIG. 1, a computing partition has various hardware allocated to it by a system operator, including one or more processors 194, volatile memory 195, non-volatile storage 196, and input and output (“I/O”) devices 197 (e.g., network cards, video display devices, keyboards, and the like). However, in HPC systems like the embodiment in FIG. 1, each computing partition has a great deal more processing power and memory than a typical desktop computer. The OS software may include, for example, a Windows® operating system by Microsoft Corporation of Redmond, Wash., or a Linux operating system. Moreover, although the BIOS may be provided as firmware by a hardware manufacturer, such as Intel Corporation of Santa Clara, Calif., it is typically customized according to the needs of the HPC system designer to support high-performance computing, as described below in more detail.

As part of its system management role, the system console 110 acts as an interface between the computing capabilities of the computing partitions 120-170 and the system operator or other computing systems. To that end, the system console 110 issues commands to the HPC system hardware and software on behalf of the system operator that permit, among other things: 1) booting the hardware, 2) dividing the system computing resources into computing partitions, 3) initializing the partitions, 4) monitoring the health of each partition and any hardware or software errors generated therein, 5) distributing operating systems and application software to the various partitions, 6) causing the operating systems and software to execute, 7) backing up the state of the partition or software therein, 8) shutting down application software, and 9) shutting down a computing partition or the entire HPC system 100. These particular functions are described in more detail in the section below entitled “System Operation.”

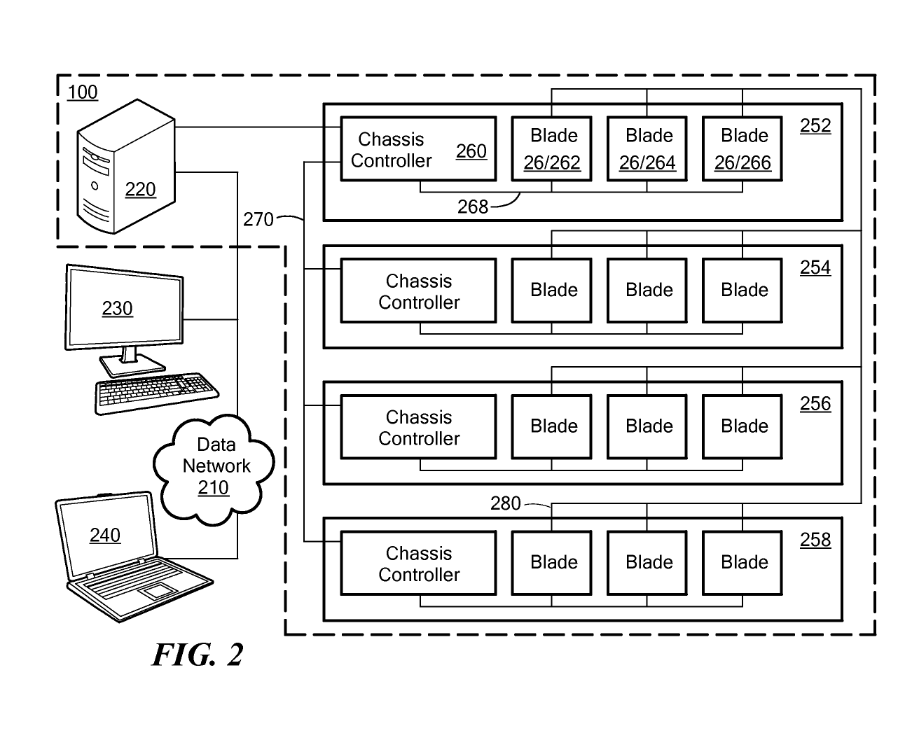

FIG. 2 schematically shows a physical view of a high performance computing system 100 in accordance with the embodiment of FIG. 1. The hardware that comprises the HPC system 100 of FIG. 1 is surrounded by the dashed line. The HPC system 100 is connected to an enterprise data network 210 to facilitate user access.

The HPC system 100 includes a system management node (“SMN”) 220 that performs the functions of the system console 110. The management node 220 may be implemented as a desktop computer, a server computer, or other similar computing device, provided either by the enterprise or the HPC system designer, and includes software necessary to control the HPC system 100 (i.e., the system console software).

The HPC system 100 is accessible using the data network 210, which may include any data network known in the art, such as an enterprise local area network (“LAN”), a virtual private network (“VPN”), the Internet, or the like, or a combination of these networks. Any of these networks may permit a number of users to access the HPC system resources remotely and/or simultaneously. For example, the management node 220 may be accessed by an enterprise computer 230 by way of remote login using tools known in the art such as Windows® Remote Desktop Services or the Unix secure shell. If the enterprise is so inclined, access to the HPC system 100 may be provided to a remote computer 240. The remote computer 240 may access the HPC system by way of a login to the management node 220 as just described, or using a gateway or proxy system as is known to persons in the art.

The hardware computing resources of the HPC system 100 (e.g., the processors, memory, non-volatile storage, and I/O devices shown in FIG. 1) are provided collectively by one or more “blade chassis,” such as blade chassis 252, 254, 256, 258 shown in FIG. 2, that are managed and allocated into computing partitions. A blade chassis is an electronic chassis that is configured to house, power, and provide high-speed data communications between a plurality of stackable, modular electronic circuit boards called “blades.” Each blade includes enough computing hardware to act as a standalone computing is server. The modular design of a blade chassis permits the blades to be connected to power and data lines with a minimum of cabling and vertical space.

Accordingly, each blade chassis, for example blade chassis 252, has a chassis management controller 260 (also referred to as a “chassis controller” or “CMC”) for managing system functions in the blade chassis 252, and a number of blades 262, 264, 266 for providing computing resources. Each blade (generically identified below by reference number “26”), for example blade 262, contributes its hardware computing resources to the collective total resources of the HPC system 100. The system management node 220 manages the hardware computing resources of the entire HPC system 100 using the chassis controllers, such as chassis controller 260, while each chassis controller in turn manages the resources for just the blades 26 in its blade chassis. The chassis controller 260 is physically and electrically coupled to the blades 262-266 inside the blade chassis 252 by means of a local management bus 268. The hardware in the other blade chassis 254-258 is similarly configured.

The chassis controllers communicate with each other using a management connection 270. The management connection 270 may be a high-speed LAN, for example, running an Ethernet communication protocol, or other data bus. By contrast, the blades 26 communicate with each other using a computing connection 280. To that end, the computing connection 280 illustratively has a high-bandwidth, low-latency system interconnect, such as NumaLink, developed by Silicon Graphics International Corp. of Fremont, Calif.

The blade chassis 252, the computing hardware of its blades 262-266, and the local management bus 268 may be provided as known in the art. However, the chassis controller 260 may be implemented using hardware, firmware, or software provided by the HPC system designer. Each blade 26 provides the HPC system 100 with some quantity of processors, volatile memory, non-volatile storage, and I/O devices that are known in the art of standalone computer servers. However, each blade 26 also has hardware, firmware, and/or software to allow these computing resources to be grouped together and treated collectively as computing partitions.

While FIG. 2 shows an HPC system 100 having four chassis and three blades in each chassis, it should be appreciated that these figures do not limit the scope of the invention. An HPC system may have dozens of chassis and hundreds of blades 26; indeed, HPC systems often are desired because they provide very large quantities of tightly-coupled computing resources.

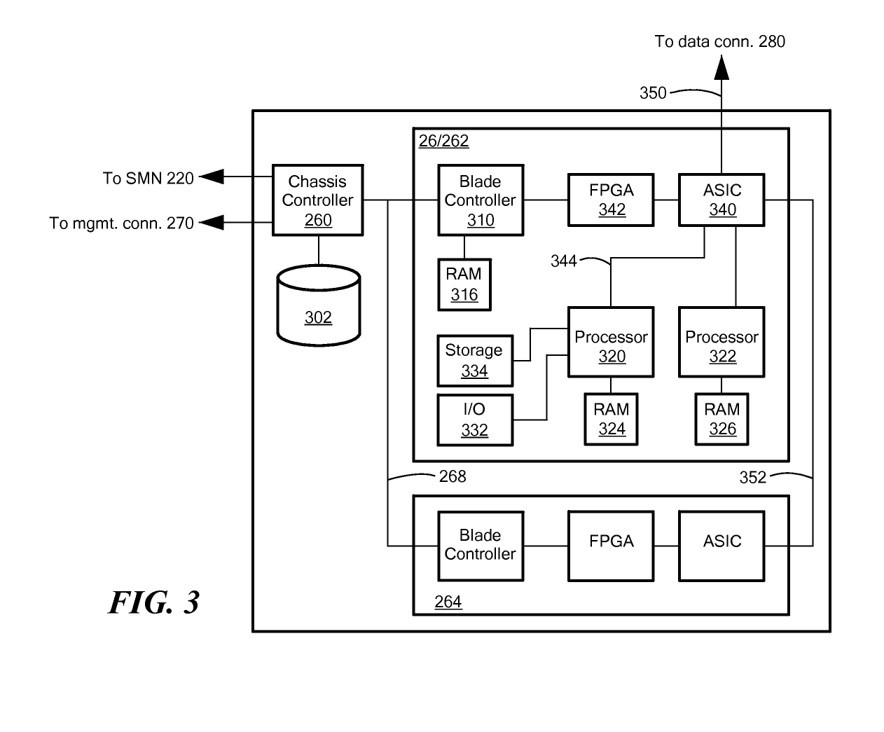

FIG. 3 schematically shows a single blade chassis 252 in more detail. In this figure, parts not relevant to the immediate description have been omitted. The chassis controller 260 is shown with its connections to the system management node 220 and to the management connection 270. The chassis controller 260 may be provided with a chassis data store 302 for storing chassis management data. In some embodiments, the chassis data store 302 is volatile random access memory (“RAM”), in which case data in the chassis data store 302 are accessible by the SMN 220 so long as power is applied to the blade chassis 252, even if one or more of the computing partitions has failed (e.g., due to an OS crash) or a blade 26 has malfunctioned. In other embodiments, the chassis data store 302 is non-volatile storage such as a hard disk drive (“HDD”) or a solid state drive (“SSD”). In these embodiments, data in the chassis data store 302 are accessible after the HPC system has been powered down and rebooted.

FIG. 3 shows relevant portions of specific implementations of the blades 262 and 264 for discussion purposes. The blade 262 includes a blade management controller 310 (also called a “blade controller” or “BMC”) that executes system management functions at a blade level, in a manner analogous to the functions performed by the chassis controller at the chassis level. The blade controller 310 may be implemented as custom hardware, designed by the HPC system designer to permit communication with the chassis controller 260. In addition, the blade controller 310 may have its own RAM 316 to carry out its management functions. The chassis controller 260 communicates with the blade controller of each blade 26 using the local management bus 268, as shown in FIG. 3 and the previous figures.

The blade 262 also includes one or more processors 320, 322 that are connected to RAM 324, 326. The blade 262 may be alternately configured so that multiple processors may access a common set of RAM on a single bus, as is known in the art. It should also be appreciated that processors 320, 322 may include any number of central processing units (“CPUs”) or cores, as is known in the art. The processors 320, 322 in the blade 262 are connected to other items, such as a data bus that communicates with I/O devices 332, a data bus that communicates with non-volatile storage 334, and other buses commonly found in standalone computing systems. (For clarity, FIG. 3 shows only the connections from processor 320 to some devices.) The processors 320, 322 may be, for example, Intel® Core™ processors manufactured by Intel Corporation. The I/O bus may be, for example, a PCI or PCI Express (“PCIe”) bus. The storage bus may be, for example, a SATA, SCSI, or Fibre Channel bus. It will be appreciated that other bus standards, processor types, and processor manufacturers may be used in accordance with illustrative embodiments of the present invention.

Each blade 26 (e.g., the blades 262 and 264) includes an application-specific integrated circuit 340 (also referred to as an “ASIC”, “hub chip”, or “hub ASIC”) that controls much of its functionality. More specifically, to logically connect the processors 320, 322, RAM 324, 326, and other devices 332, 334 together to form a managed, multi-processor, coherently-shared distributed-memory HPC system, the processors 320, 322 are electrically connected to the hub ASIC 340. The hub ASIC 340 thus provides an interface between the HPC system management functions generated by the SMN 220, chassis controller 260, and blade controller 310, and the computing resources of the blade 262.

In this connection, the hub ASIC 340 connects with the blade controller 310 by way of a field-programmable gate array (“FPGA”) 342 or similar programmable device for passing signals between integrated circuits. In particular, signals are generated on output pins of the blade controller 310, in response to commands issued by the chassis controller 260. These signals are translated by the FPGA 342 into commands for certain input pins of the hub ASIC 340, and vice versa. For example, a “power on” signal received by the blade controller 310 from the chassis controller 260 requires, among other things, providing a “power on” voltage to a certain pin on the hub ASIC 340; the FPGA 342 facilitates this task.

The hub chip 340 in each blade 26 also provides connections to other blades 26 for high-bandwidth, low-latency data communications. Thus, the hub chip 340 includes a link 350 to the computing connection 280 that connects different blade chassis. This link 350 may be implemented using networking cables, for example. The hub ASIC 340 also includes connections to other blades 26 in the same blade chassis 252. The hub ASIC 340 of blade 262 connects to the hub ASIC 340 of blade 264 by way of a chassis computing connection 352. The chassis computing connection 352 may be implemented as a data bus on a backplane of the blade chassis 252 rather than using networking cables, advantageously allowing the very high speed data communication between blades 26 that is required for high-performance computing tasks. Data communication on both the inter-chassis computing connection 280 and the intra-chassis computing connection 352 may be implemented using the NumaLink protocol or a similar protocol.

With all those system components, the HPC system 100 would become overheated without an adequate cooling system. Accordingly, illustrative embodiments of the HPC system 100 also have a liquid cooling system for cooling the heat generating system components. Unlike prior art liquid cooling systems known to the inventor, however, removal or attachment of a blade 26 does not open or close its liquid channels/fluid circuits. For example, prior art systems known to the inventor integrate a portion of the cooling system with the blade 26. Removal or attachment of a prior art blade 26, such as during a hot swap, thus opened the liquid channel of the prior art cooling system, endangering the life of the technician and, less important but still significant, potentially damaging the overall HPC system 100. Illustrative embodiments mitigate these serious risks by separating the cooling system from the blade 26, eliminating this problem.

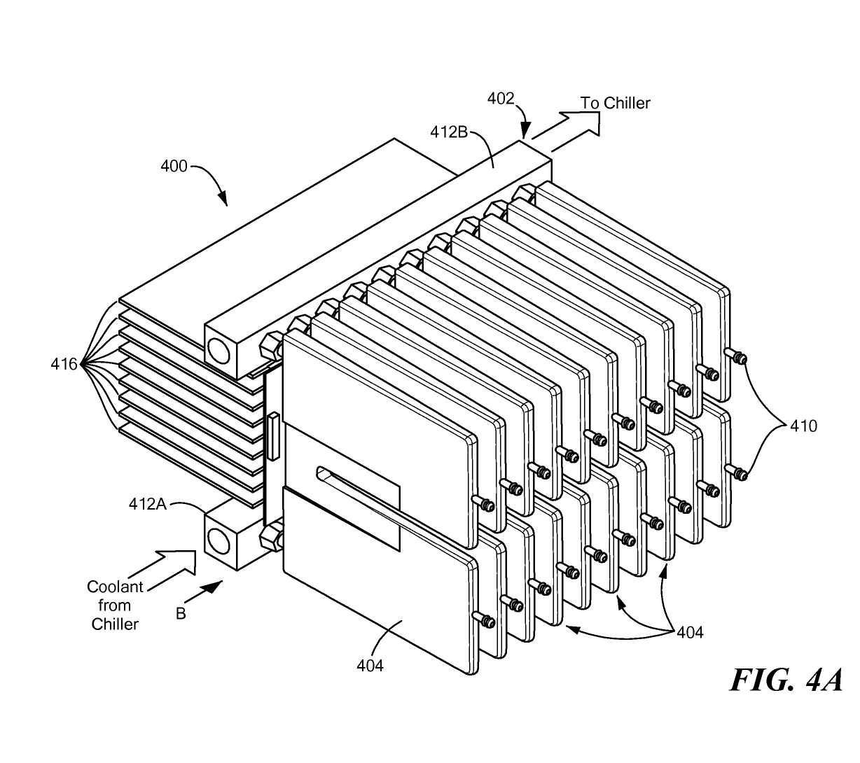

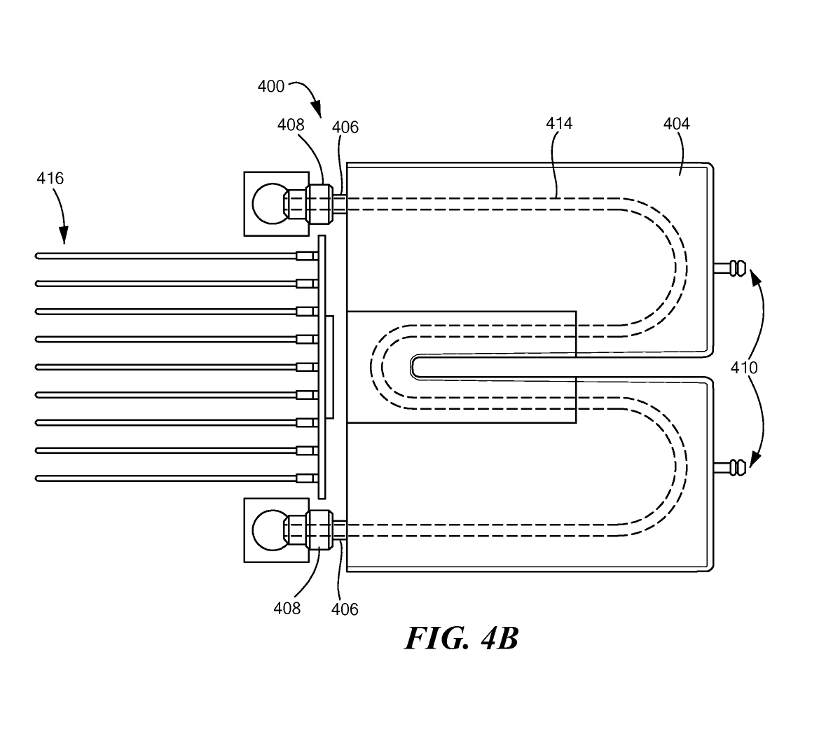

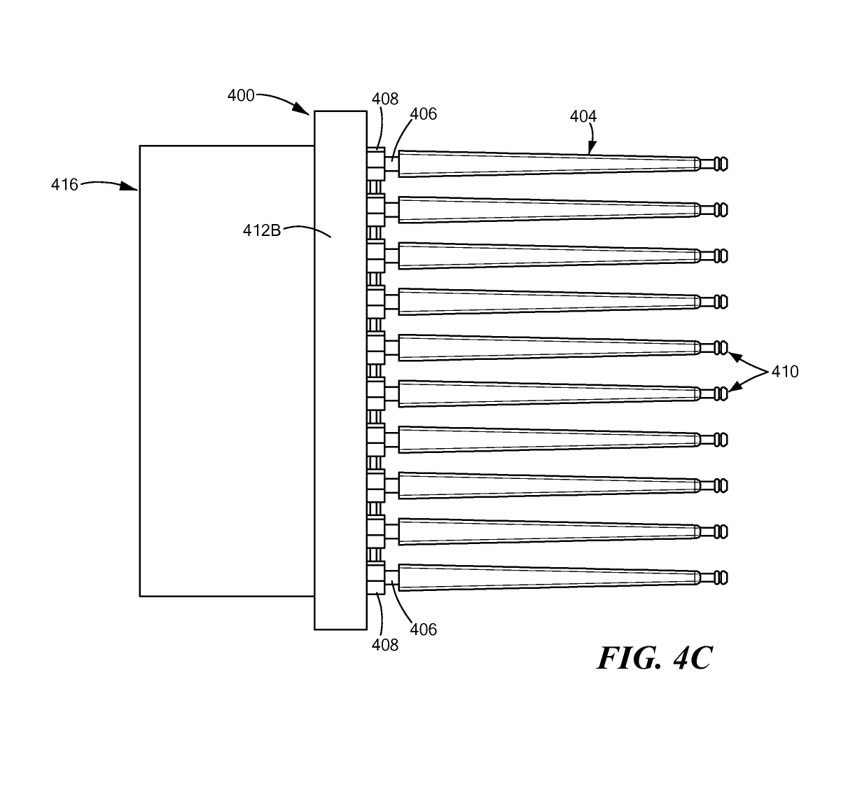

To that end, FIG. 4A schematically shows a portion of an HPC cooling system 400 configured in accordance with illustrative embodiments of the invention. For more details, FIG. 4B schematically shows a side view of the portion shown in FIG. 4A from the direction of arrow “B”, while FIG. 4C schematically shows a top view of the same portion.

The cooling system 400 includes a main portion 402 supporting one or more cold plates 404 (a plurality in this example), and corresponding short, closed fluid/liquid line(s) 406 (best shown in FIGS. 4B and 4C) extending between the main portion 402 and the cold plate(s) 404. The short lines 406 preferably each connect with a plurality of corresponding seals 408, such as O-ring seals 408, in a manner that accommodates tolerance differences in the fabricated components. For example, to accommodate tolerance differences, the short lines 406 can be somewhat loosely fitted to float in and out of their respective O-ring seals 408. Indeed, other embodiments may seal the channels with other types of seals. Accordingly, those skilled in the art may use seals (for the seal 408) other than the O-rings described and shown in the figures.

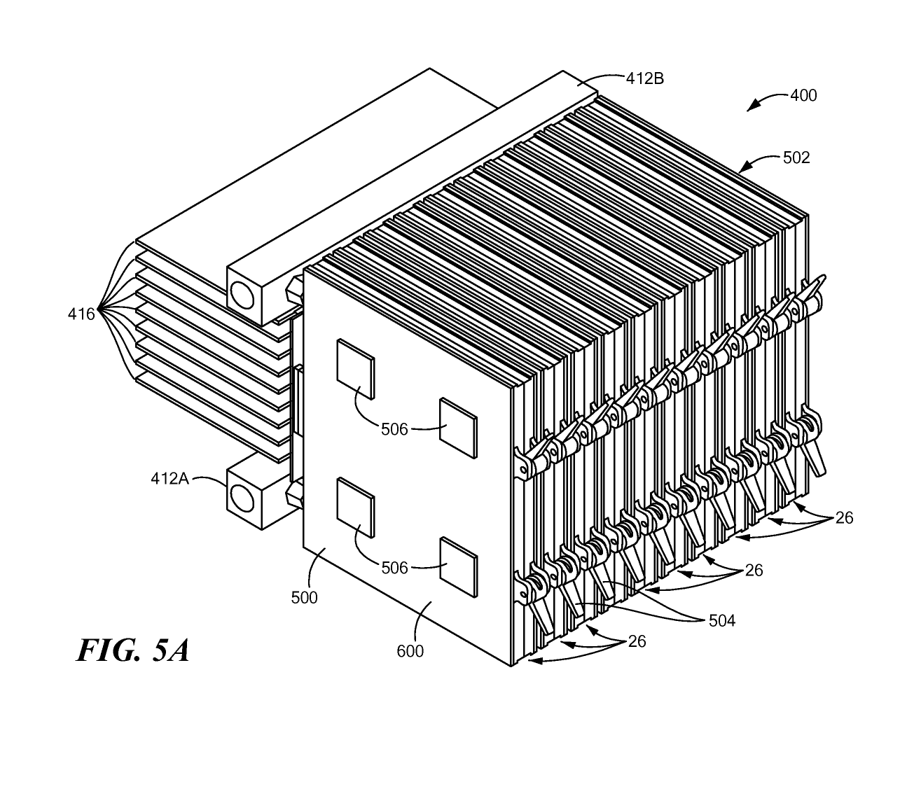

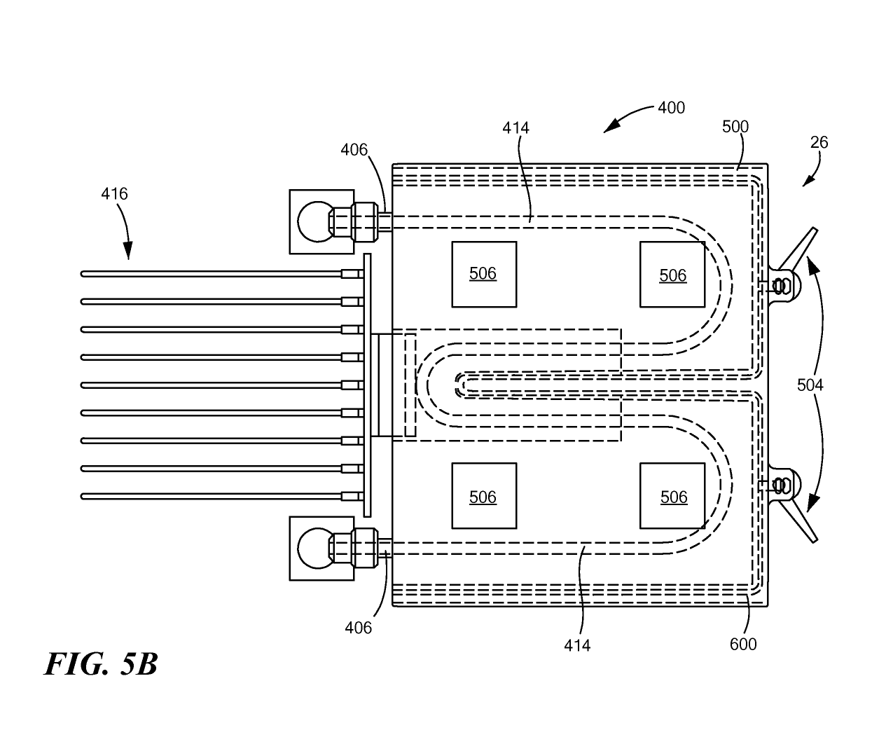

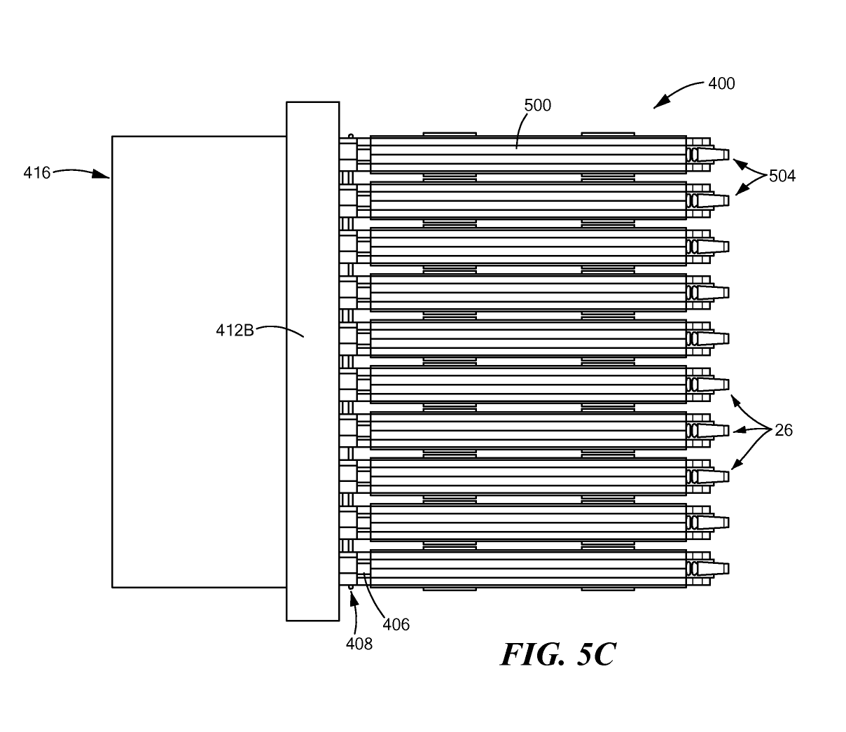

As discussed below with regard to FIG. 5A, each cold plate 404 as shown in FIGS. 4A-4C is shaped and configured to removably connect with a specially configured computing module, which, in this embodiment, is a blade carrier 500 carrying one or more blades 26 (discussed in greater detail below with regard to FIGS. 5A, 6A, and 7A). Each cold plate 404 includes a pair of coupling protrusions 410 (see FIGS. 4A and 4C) that removably couple with corresponding connectors of each blade carrier 500 for a secure and removable connection. That connection is discussed in greater detail below with regard to FIGS. 5A-5C.

The cooling system 400 is considered to form a closed liquid channel/circuit that extends through the main portion 402, the short liquid lines, and the cold plates 404. More specifically, the main portion 402 of the cooling system 400 has a manifold (generally referred to using reference number “412”), which has, among other things:

1) a supply manifold 412A for directing cooler liquid coolant, under pressure, toward the plurality of blades 26 via the inlet short lines 406, and

2) a receiving manifold 412B for directing warmer liquid away from the plurality of blades 26 via their respective outlet short lines 406.

Liquid coolant therefore arrives from a cooling/chilling device (e.g., a compressor, chiller, or other chilling apparatus, not shown) at the supply manifold 412A, passes through the short lines 406 and into the cold plates 404. This fluid/liquid circuit preferably is a closed fluid/liquid loop during operation. In illustrative embodiments, the chiller cools liquid water to a temperature that is slightly above the dew point (e.g., one or two degrees above the dew point). For example, the chiller may cool liquid water to a temperature of about sixty degrees before directing it toward the cold plates 404.

As best shown in FIG. 4B, the coolant passes through a liquid channel 414 within each cold plate 404, which transfers heat from the hot electronic components of an attached blade 26 to the coolant. It should be noted that the channels 414 are not visible from the perspectives shown in the figures. Various figures have drawn the channels 414 in phantom through their covering layers (e.g., through the aluminum bodies of the cold plates 404 that cover them from these views). In illustrative embodiments, the channel 414 within the cold plate 404 is arranged in a serpentine shape for increased cooling surface area. Other embodiments, however, may arrange the channel 414 within the cold plates 404 in another manner. For example, the channel 414 may simply be a large reservoir with an inlet and an outlet. The coolant then passes from the interior of the cold plates 404 via a short line 406 to the receiving manifold 412B, and then is directed back toward the chiller to complete the closed liquid circuit. The temperature of the coolant at this point is a function of the amount of heat it extracts from the blade components. For example, liquid water coolant received at about sixty degrees may be about seventy or eighty degrees at this point.

The cold plates 404 may be formed from any of a wide variety of materials commonly used for these purposes. The choice of materials depends upon a number of factors, such as the heat transfer coefficient, costs, and type of liquid coolant. For example, since ethylene glycol typically is not adversely reactive with aluminum, some embodiments form the cold plates 404 from aluminum if, of course, ethylene glycol is the coolant. Recently, however, there has been a trend to use water as the coolant due to its low cost and relatively high heat transfer capabilities. Undesirably, water interacts with aluminum, which is a highly desirable material for the cold plate 404. To avoid this problem, illustrative embodiments line the liquid channel 414 (or liquid chamber 414) through the cold plate 404 with copper or other material to isolate the water from aluminum.

Those skilled in the art size the cold plate as a function of the blade carriers 500 it is intended to cool. Among other things, those skilled in the art can consider, among other things, the type of coolant used, the power of the HPC system 100, the surface area of the cold plates 404, the number of chips being cooled, and the type of thermal interface film/grease used (discussed below).

This cooling system 400 may be connected with components, modules, or systems other than the blade carriers 500. For example, FIGS. 4A-4C show a plurality of additional circuit boards 416 connected with the cooling system 400 via a backplane or other electrical connector. These additional circuit boards 416 are not necessarily cooled by the cooling system 400. Instead, they simply use the cooling system 400 as a mechanical support. Of course, other embodiments may configure the cooling system 400 to cool those additional circuit boards 416 in a similar manner.

FIG. 5A schematically shows the cooling system 400 with a plurality of blade carriers 500 coupled to its cold plates 404. In a manner similar to FIGS. 4B and 4C, FIG. 5B schematically shows a side view of the portion shown in FIG. 5A, while FIG. 5C schematically shows a top view of the same portion.

Each cold plate 404 is removably coupled to one corresponding blade carrier 500 to form a plurality of cooling pairs 502. In other words, each cold plate 404 cools one blade carrier 500. To that end, each blade carrier 500 has a mechanism for removably securing with its local cold plate 404. As best shown in FIGS. 5A and 5B, the far end of each blade carrier 500 has a pair of cam levers 504 that removably connect with corresponding coupling protrusions 410 on its cold plate 404. Accordingly, when in the fully up position (from the perspective of FIG. 5B), the cam levers 504 are locked to their coupling protrusions 410. Conversely, when in the fully down position, the cam levers 504 are unlocked and can be easily removed.

Indeed, those skilled in the art can use other removable connection mechanisms for easily removing and attaching the blade carriers 500. For example, wing nuts, screws, and other similar devices, among other things, should suffice. Of course, among other ways, a connection may be considered to be removably connected when it can be removed and returned to its original connection without making permanent changes to the underlying cooling system 400. For example, a cooling system 400 requiring one to physically cut, permanently damage, or unnaturally bend the coupling mechanism, cold plate 404, or blade carrier 500, is not considered to be “removably connected.” Even if the component can be repaired after such an act to return to its original, coupled relationship with its corresponding part, such a connection still is not “removably connected.” Instead, a simple, repeatable, and relatively quick disconnection is important to ensure a removable connection.

As noted above, each blade carrier 500 includes at least one blade 26. In the example shown, however, each blade carrier 500 includes a pair of blades 26—one forming/on its top exterior surface and another forming/on its bottom exterior surface. As best shown in FIG. 5B, each blade 26 has a plurality of circuit components, which are schematically represented as blocks 506. Among other things, those components 506 may include microprocessors, ASICs, etc.

To increase processing density, the cooling pairs 502 are closely packed in a row formed by the manifold 412. The example of FIG. 5C shows the cooling pairs 502 so closely packed that the circuit components are nearly or physically contacting each other. Some embodiments laterally space the components of different blade carriers 500 apart in a staggered manner, while others add insulative material between adjacent chips on different, closely positioned blade carriers 500. Moreover, various embodiments have multiple sets of cooling systems 400 and accompanying blade carriers 500 as shown in FIGS. 5A-5C.

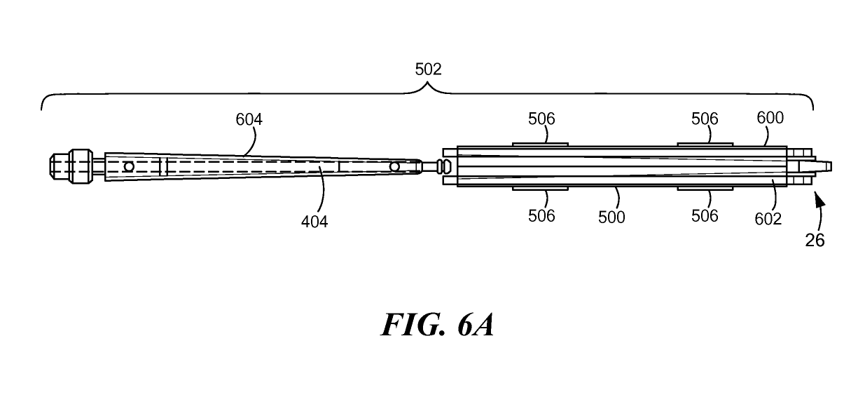

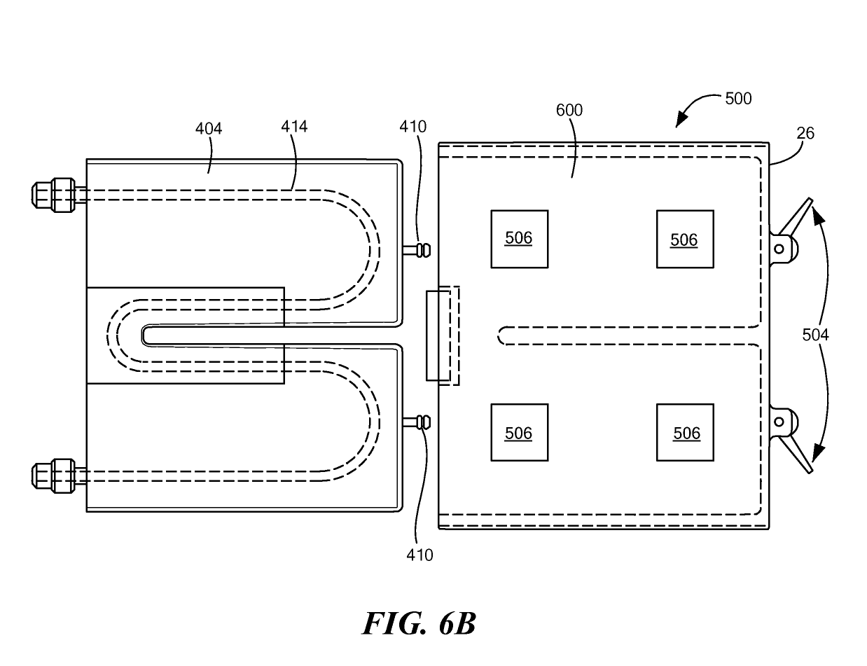

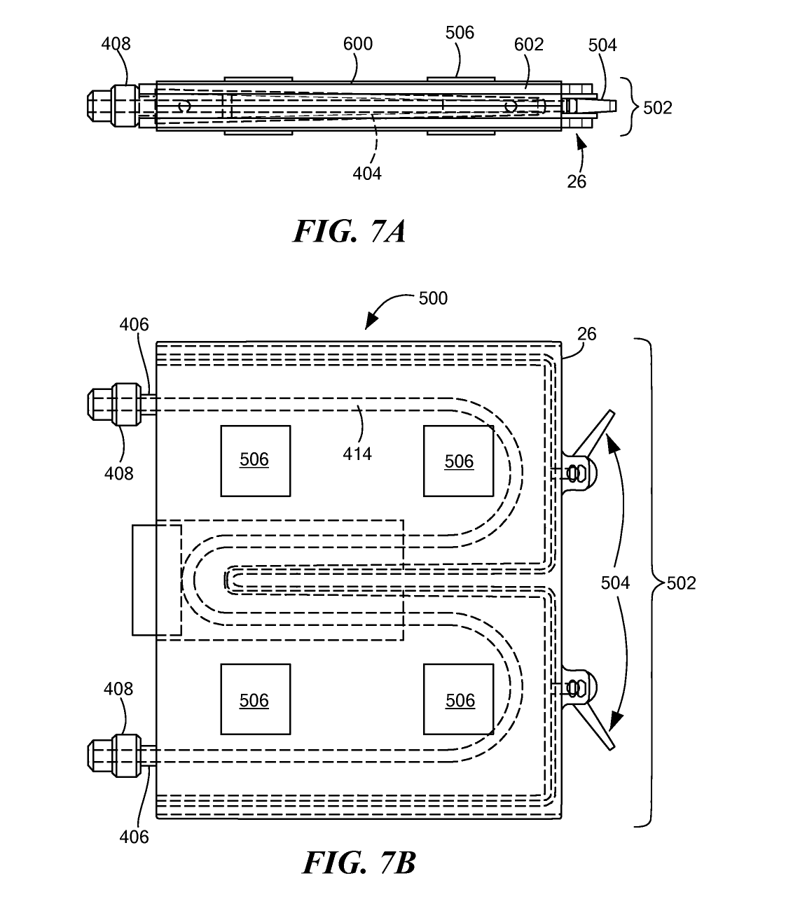

FIGS. 6A and 6B respectively show cross-sectional and top views of one cooling pair 502 prior to coupling, while FIGS. 7A and 7B respectively show cross-sectional and top views of that same cooling pair 502 when (removably) coupled. Before discussing the coupling process, however, it is important to note several features highlighted by FIGS. 6A and 7A. First, FIGS. 6A and 7A show more details of the blade carrier 500, which includes various layers that form an interior chamber 604 for receiving a complimentarily configured cold plate 404. In particular, on each side of the blade carrier 500, the layers include the noted components 506 mounted to a printed circuit board 600, and a low thermal resistance heat spreader 602 that receives and distributes the heat from the printed circuit board 600 and exchanges heat with its coupled cold plate 404. These layers thus form the noted interior chamber 604, which receives the cold plate 404 in a closely fitting mechanical connection.

More specifically, the exterior size and shape of the cold plate 404 preferably compliments the size and shape of the interior chamber 604 of the blade carrier 500. In this way, the two components fit together in a manner that produces a maximum amount of surface area contact between both components when fully connected (i.e., when the cold plate 404 is fully within the blade carrier 500 and locked by the cam levers 504). Accordingly, the outside face of the cold plate 404 (i.e., the face having the largest surface area as shown in FIG. 6B) is substantially flush against the interior surface of the interior chamber 604 of the blade carrier 500. This direct surface area contact is expected to produce a maximum heat transfer between the blade carrier 500 and the cold plate 404, consequently improving cooling performance. When coupled together in this manner, the components thus are considered to be “in registry” with each other—they may be considered to fit together “like a glove.”

Undesirably, in actual use, the outside surface of the cold plate 404 may not make direct contact with all of the interior chamber walls. This can be caused by normally encountered machining and manufacturing tolerances. As such, the cooling system 400 may have one or more air spaces between the cold plate 404 and the interior chamber walls. These air spaces can be extensive—forming thin but relatively large air-filled regions. Since air is a thermal insulator, these regions can significantly impede heat transfer in those regions, reducing the effectiveness of the overall cooling system 400.

In an effort to avoid forming these air-filled regions, illustrative embodiments place a thermal conductor between at least a portion of the outside of the cold plates 404 and the interior chamber walls—i.e., between their facing surfaces. For example, illustrative embodiments may deposit or position a thermal film or thermal grease across the faces of the cold plate 404 and/or interior chamber walls to fill potential air-filled regions. While it may not be as good a solution as direct face-to-face contact between the cold plate 404 and interior chamber walls, the thermal film or grease should have a much greater thermal conductivity coefficient than that of air, thus mitigating manufacturing tolerance problems.

While this thermally conductive layer should satisfactorily improve the air-filled region issue, the inventor realized that repeated removal and reconnection of the blade carrier 500 undesirably can remove a significant amount of the thermal film/grease. Specifically, the inventor realized that during attachment or removal, the constant scraping of one surface against the other likely would scrape off much of the thermal film/grease. As a result, the cooling system 400 requires additional servicing to reapply the thermal film/grease. Moreover, this gradual degradation of the thermal film/grease produces a gradual performance degradation.

The inventor subsequently recognized that he could reduce thermal film/grease loss by reducing the time that the two faces movably contact each other during the removal and attachment process. To that end, the inventor discovered that if he formed those components at least partly in a diverging shape (e.g., a wedge-shape), the two surfaces likely could have a minimal amount of surface contact during attachment or removal.

Accordingly, in illustrative embodiments, FIGS. 6A and 7A schematically show the interior chamber 604 and cold plate 404 as having complimentary diverging shapes and sizes. More particularly, the interior chamber 604 shown has its widest radial dimension (thickness) at its opening and continually linearly tapers/diverges toward a smallest radial dimension at its far end (to the right side from the perspective of FIGS. 6A and 7A). In a similar manner, the leading edge of the cold plate 404 has its smallest radial dimension, while the back end (i.e., its left side) has the largest radial dimension. Rather than a constant tapering/divergence, alternative embodiments taper along selected portions only. For example, the interior chamber 604 and cold plate 404 could have shapes with an initial linearly tapering portion, followed by a straight portion, and then a second linearly tapering portion. In either case, if carefully inserting or removing the cold plate 404, the tight, surface-to-surface contact (with the thermal film/grease in the middle) should occur at the end of the insertion step only.

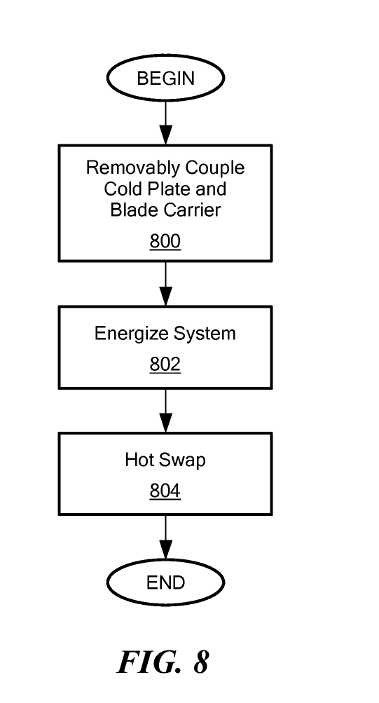

Hot swapping the blade carrier 500 thus should be simple, quick, and safe. FIG. 8 shows a process of attaching and removing a blade carrier 500 in accordance with illustrative embodiments of the invention. This process can be repeated for one or more than one of the cooling pairs 502. It should be noted that this process is a simple illustration and thus, can include a plurality of additional steps. In fact, some of the steps may be performed in a different order than that described below. Accordingly, FIG. 8 is not intended to limit various other embodiments of the invention.

The process begins at step 800, in which a technician removably couples a cold plate 404 with a blade carrier 500 before the HPC system 100 and cooling system 400 are energized. Since the cooling system 400 and its cold plate 404 are large and stationary, the technician manually lifts the blade carrier 500 so that its interior chamber substantially encapsulates one of the cold plates 404 to form a cooling pair 502. While doing so, to protect the thermal layer/grease, the technician makes an effort not to scrape the interior chamber surface against the cold plate 404.

Accordingly, the technician preferably substantially co-axially positions the cold plate body with the axis of the interior chamber 604, ensuring a minimum of pre-coupling surface contact. Illustrative embodiments simply use the technician's judgment to make such an alignment. In alternative embodiments, however, the technician may use an additional tool or device to more closely make the idealized alignment. After the cold plate 404 is appropriately positioned within the interior chamber 604, the technician rotates the cam levers 504 to lock against their corresponding coupling protrusions 410 on the cold plates 404. At this stage, the cold plate 404 is considered to be removably connected and in registry with the blade carrier 500.

Next, at step 802, the technician energizes the HPC system 100, including the cooling system 400 (if not already energized), causing the blade(s) 26 to operate. Since the components on the blades 26 generate waste heat, this step also activates the cooling circuit, causing coolant to flow through the cold plate 404 and removing a portion of the blade waste heat. In alternative embodiments, steps 800 and 802 may be performed at the same time, or in the reverse order.

At some later time, the need to change the blade carrier 500 may arise. Accordingly, step 804 hot swaps the blade carrier 500. To that end, the technician rotates the cam levers 504 back toward an open position, and then carefully pulls the blade carrier 500 from its mated connection with its corresponding cold plate 404. This step is performed while the cooling system 400 is under pressure, forcing the coolant through its fluid circuit. In a manner similar to that described with regard to step 800, this step preferably is performed in a manner that minimizes contact between the cold plate 404 and interior chamber surface. Ideally, there is no surface contact after the first minute outward movement of the blade carrier 500. As with the insertion process of step 800, the technician may or may not use an additional tool or device as a blade carrier removal aid.

To complete the hot swapping process, the technician again removably couples the originally removed blade carrier 500, or another blade carrier 500, with the cold plate 404. In either case, the HPC system 100 is either fully powered or at least partly powered during the hot swap process. There is no need to power-down the HPC system 100. The cooling system 400 thus cycles/urges coolant, under pressure, to flow through its internal circuit before, during, and/or after hot swapping the blade carrier 500.

Accordingly, the cooling system 400 makes only a mechanical connection with the blade carrier 500—it does not make a fluid connection with the blade carrier 500 or the blade 26 itself. This enables the technician to hot swap a blade 26 without opening the fluid circuit/channel (the fluid circuit/channel remains closed with respect to the blade carrier 500—in the vicinity of the blade carrier 500). The sensitive system electronics therefore remain free of inadvertent coolant spray, drips, or other leakage during the hot swap, protecting the life of the technician and the functionality of the HPC system 100. In addition, illustrative embodiments facilitate use of water, which favorably is an inexpensive, plentiful, and highly thermally conductive coolant in high temperature, hot swappable applications. More costly, less thermally favorable coolants no longer are necessary.

Although the above discussion discloses various exemplary embodiments of the invention, it should be apparent that those skilled in the art can make various modifications that will achieve some of the advantages of the invention without departing from the true scope of the invention.

What is claimed is:

1. A computer system comprising:
a liquid cooling system having a main portion and a cold plate, the liquid cooling system having a closed fluid line extending between the main portion and the cold plate, the cold plate including an internal liquid chamber fluidly connected to the closed fluid line extending between the main portion and the cold plate; and
a hot swappable computing module removably connectable with the cold plate,
the cold plate and computing module being configured to maintain the closed fluid line between the main portion and the cold plate when the computing module is being connected to or removed from the cold plate.

2. The computer system as defined by claim 1 wherein the computing module comprises a blade.

3. The computer system as defined by claim 1 wherein the liquid cooling system includes a closed fluid loop that includes the internal liquid chamber within the cold plate.

4. The computer system as defined by claim 1 wherein the cold plate and computing module have complimentary shapes to fit in registry when connected.

5. The computer system as defined by claim 4 wherein the computing module forms an internal fitting space having a first shape, the exterior of the cold plate having the first shape and sized to fit within the fitting space.

6. The computer system as defined by claim 5 wherein the first shape includes a linearly tapering portion.

7. The computer system as defined by claim 1 wherein the main portion includes a manifold coupled with the cold plate, the manifold having a receiving manifold portion configured to receive a liquid coolant from the computing module, the manifold further having a supply manifold portion configured to direct the liquid coolant toward the internal liquid chamber of the cold plate.

8. The computer system as defined by claim 1 wherein the computing module includes a printed circuit board and a plurality of integrated circuits.

9. The computer system as defined by claim 1 wherein the computing module includes a module face, the cold plate having a plate face that is facing the module face, the system further including a thermal film contacting both the module face and the plate face to provide a continuous thermal path between at least a portion of the two faces.

10. A high performance computing system comprising:
a liquid cooling system having a main portion and a plurality of cold plates, the liquid cooling system having a closed fluid line extending between the main portion and a plurality of the cold plates; and
a plurality of hot swappable computing modules, each of the plurality of computing modules being removably connectable with one of the cold plates to form a plurality of cooling pairs,
the cold plate and computing module of each cooling pair being configured to maintain the closed fluid line between the main portion and the cold plate when the computing module is being connected to or removed from the cold plate.

11. The high performance computing system as defined by claim 10 wherein at least one of the computing modules comprises a blade.

12. The high performance computer system as defined by claim 10 wherein a set cooling pairs each has its computing module forming an internal fitting space having a first shape, the cold plate of each of the set of cooling pairs also having an exterior with the first shape and sized to fit within the internal fitting space.

13. The high performance computer system as defined by claim 12 wherein the first shape includes a linearly tapering portion.

14. The high performance computer system as defined by claim 10 wherein the main portion includes a manifold coupled with the cold plates, the manifold having a receiving manifold portion configured to receive a liquid coolant from the computing modules, the manifold further having a supply manifold portion configured to direct the liquid coolant toward the internal liquid chambers of the cold plates.

15. The high performance computer system as defined by claim 10 wherein the computing module of each cooling pair includes a module face, the cold plate of each cooling pair having a plate face facing the module face, each cooling pair further including a thermal film contacting both the module face and the plate face to provide a continuous thermal path between at least a portion of the two faces.

16. A method of cooling a blade of a computer system, the method comprising:
providing a liquid cooling system having a main portion and a plurality of cold plates, the liquid cooling system having a closed fluid line extending between the main portion and the cold plates;
removably coupling each of a set of the cold plates in registry with one of a plurality of computing modules, each cold plate and respective coupled computing module forming a cooling pair and forming a part of the computer system;
energizing the computing modules; and
hot swapping at least one of the computing modules while maintaining the closed fluid line between the main portion and the cold plate.

17. The method as defined by claim 16 wherein each of the computing modules in the cooling pairs forms an internal fitting space having a first shape, the exterior of the respective cold plate having the first shape and sized to fit within the fitting space.

18. The method as defined by claim 17 wherein the first shape includes a linearly tapering portion.

19. The method as defined by claim 16 wherein the computer system includes a high performance computing system and the plurality of computing modules includes a plurality of blades.

20. The method as defined by claim 16 wherein hot swapping includes removing at least one of the computing modules while the computer system is energized and the closed fluid line is pressurized.

21. The method as defined by claim 16 further comprising cycling coolant liquid through the liquid cooling system and the cold plate before, during, and after hot swapping the at least one computing module.
